(19) United States
(12) Patent Application Publication
(10) Pub. No.: US 2006/0164998 A1
(43) Pub. Date: Jul. 27, 2006

(54) System and method for detecting added network connections including wiretaps

(75) Inventor: Art Pharn, Huntington Beach, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation, Irvine, CA (US)

(21) Appl. No.: 11/042,179

(22) Filed: Jan. 26, 2005

(51) Int. Cl. H04L 12/26; H04J 3/14; H04J 1/16

(52) U.S. Cl. 370/241

(57) ABSTRACT

A TDR (Time Domain Reflectometry) circuit associated with a computer network device monitors a network connection to identify changes in that connection. The disclosed system and method may provide notification when a possible attempt to intercept signals in the network has been detected, and may be automatically controlled to perform periodic monitoring of the network.

### FIELD OF THE INVENTION

The present invention relates generally to apparatus and methods for determining whether a connection has been added to a network.

### BACKGROUND OF THE INVENTION

Conventional Ethernet (10 Mbit data rate) and Fast Ethernet (nominal 100 MBit data rate) employ four of the eight wires in a typical Ethernet cable. New higher speed networking standards, such as Gigabit Ethernet, require all of the wires in Ethernet cabling to carry signals. Typically the four wires used for an existing Ethernet or Fast Ethernet connection were tested and certified when the cabling was installed. However, if an existing Ethernet network is to be upgraded to Gigabit operations, there is a need to determine whether the wires currently in place, some of which may never have been used or tested, will provide a satisfactory electrical connection for Gigabit Ethernet. There is a good possibility that some existing wiring was not properly connected or sustained damage subsequent to installation. These problems are often unrecognized in cases where the poorly connected or damaged wires were never used.

One approach to diagnosis of these problems has been to apply Time Domain Reflectometry (TDR) methodologies. The best-known example of TDR is radio detection and ranging (RADAR), which in general detects a distant object by measuring reflections of a signal transmitted toward that object. As applied in the field of electronic connections, TDR provides impedance analysis of a conductor (wire, cable, or fiber optic) by sending a phased signal into the conductor, and then examining the time domain reflection of that pulse.

In the past, TDR testing for electronic circuits was only available in specialized test equipment. More recently, certain TDR testing capabilities have been provided in switches and other physical level interface (PHY) devices, such as those deployed for certain Gigabit Ethernet systems. These testing capabilities may assist in determining whether the network infrastructure will support gigabit data transfer, and may enable network managers to selectively upgrade an existing network to support higher speed operation.

TDR approaches work in this context because when a cable has been damaged (crimped, cut, shorted or disengaged), this modifies the cable's properties, changing its effect on the electrical signals that are sent through it. A short circuit, for example, offers low resistance to current. A severed cable produces an open circuit that blocks data transfer. When an electrical pulse transmitted by a TDR testing device encounters a resistance, part or all of that pulse will be reflected back to the device. An algorithm is then employed to determine whether the reflection indicates a fault, and to inform the user of any faults that would be a barrier to effective communications. The algorithm may also identify the likely location of a detected fault, based upon features of the reflected pulse such as polarity, amplitude, shape and the time taken for it to reflect to the signal source.

Insofar as the inventor is aware, the TDR testing circuits included in networking switches and PHY devices have been used only for detecting cabling faults that would interfere with high data rate transmission, and not for other purposes.

A variety of protocols have been developed and implemented to ensure security of the information traveling over data networks. For example, the IP Security (IPSEC) protocols developed by the Internet Engineering Task Force (IETF) have been widely implemented in Virtual Private Network (VPN) schemes. However, these protocols provide only electronic security, and do not address physical security of the network connections. Network cabling typically passes through walls and ceilings in an unsecured manner and can be physically accessed and tapped at a variety of locations in most commercial buildings.

Therefore, the inventor believes there is a need for improved systems and methods for monitoring security in computer networks.

### BRIEF SUMMARY OF THE INVENTION

Additional features and advantages of various aspects and embodiments of the invention will be set forth in the description which follows, and in part will be apparent from the description, or may be learned by practice of the invention.

In an exemplary embodiment, a TDR (Time Domain Reflectometry) detector associated with a computer network device is used to monitor a network connection to identify changes in that connection. In an embodiment, appropriate persons are notified of detected changes that may indicate an attempt to intercept signals in the network. In an embodiment, this monitoring is performed automatically and periodically.

It is to be understood that both the foregoing general description and the following detailed description are exemplary and explanatory and are intended to provide further explanation of the invention as claimed. The summary, abstract, and detailed description are not intended to limit the scope of the claimed invention in any way.

### BRIEF DESCRIPTION OF THE FIGURES

The accompanying drawings, which are included to provide a further understanding of exemplary embodiments of the invention and are incorporated in and constitute a part of this specification, illustrate embodiments of the invention and together with the description serve to explain the principles of the invention. In the drawings:

FIG. 1 is a block schematic diagram of a network including TDR detection circuits.

FIG. 2 is a block schematic diagram of the network of FIG. 1 with the introduction of an unauthorized connection.

FIG. 3 is a flow chart showing an embodiment of a process for monitoring a network connection for unauthorized connections.

FIG. 4 is a flow chart showing another embodiment of a process for monitoring a network connection for unauthorized connections.

FIG. 5 is a graphical representation of a typical reflection of a TDR pulse with proper cable termination.

FIG. 6 is a graphical representation of a typical reflection of a TDR pulse in the presence of a tapped connection.

FIG. 7 is a graphical representation of a typical reflection of a TDR pulse where an open cable condition exists.

FIG. 8 is a graphical representation of a typical reflection of a TDR pulse where there is a short circuit in the cable.

FIG. 9 is a block schematic diagram showing an exemplary computing device that can be used in the context of the disclosure.

Exemplary embodiments of the present invention will now be described with reference to the accompanying drawings. In the drawings, like reference numbers may indicate identical or functionally similar elements. Additionally, the left-most digit(s) of a reference number may identify the drawing in which the reference number first appears.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

The present invention will be described in terms of several embodiments applicable to Ethernet networking. It will be understood that the essential concepts disclosed herein are applicable to a wide range of connectivity approaches, and are not limited to systems following Ethernet standards. Thus, although the invention will be disclosed and described using several Ethernet implementations as examples, the scope of the invention is not in any way limited to this field.

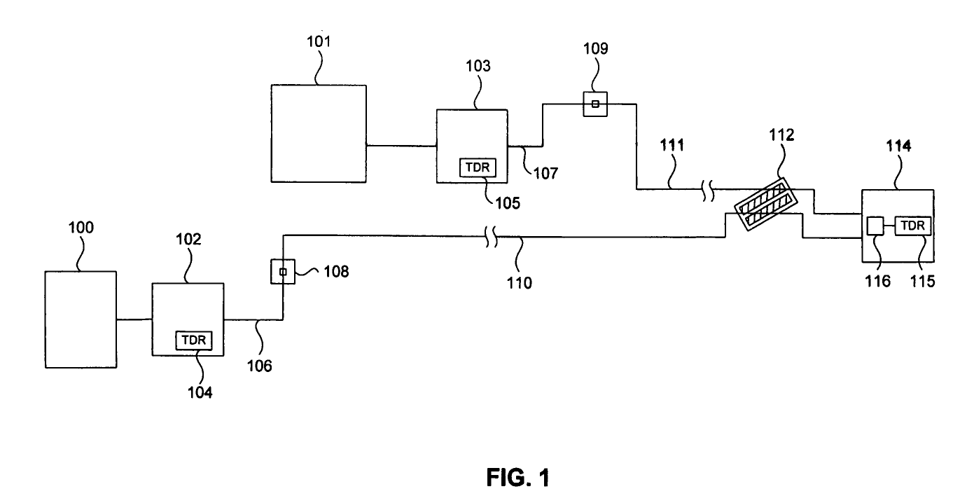

FIG. 1 is a block schematic diagram of a network, illustrating one possible implementation of several features of the present invention. The network shown in FIG. 1 comprises computing devices 100 and 101 and associated network interfaces 102 and 103, each incorporating a Time Domain Reflectometry (TDR) circuit shown as 104 and 105 respectively.

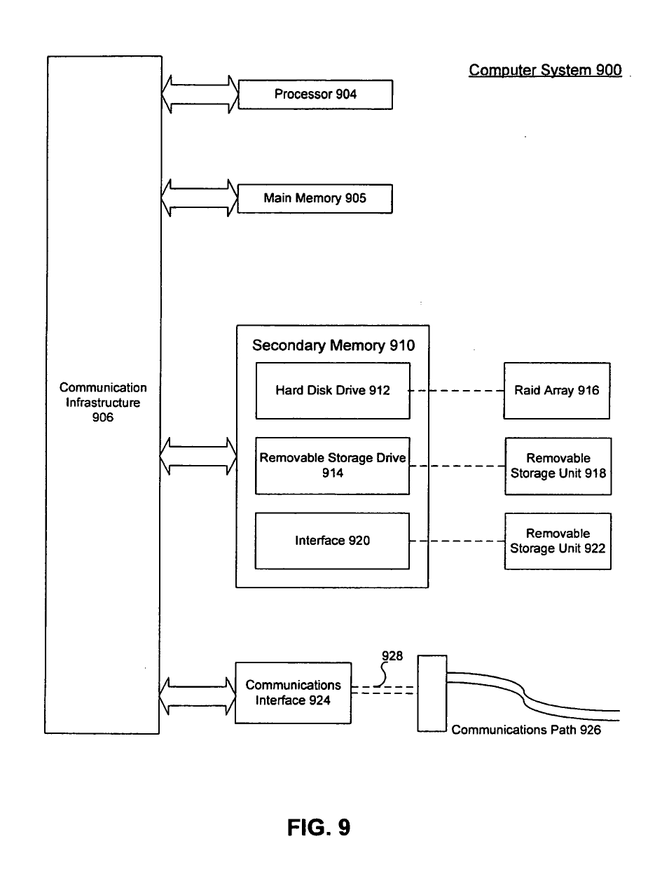

Computing devices 100 and 101 may be any type of computing device. As non-limiting examples, computing devices 100 and 101 may be personal digital assistants, industrial controllers, personal computers, portable computers, embedded controllers, integrated devices, electronic home device control circuits, or any other type of device having at least a minimal processor and a capacity for network data transmission or reception. In an embodiment, computing devices 100 and 101 may be general purpose computing devices having one or more of the features shown in FIG. 9 herein and described in the text accompanying FIG. 9.

Network interfaces 102 and 103 may provide, among other functions, physical layer connectivity and/or protocol generation as needed for computing devices 100 or 101 to transmit and/or receive data via the network. Network interfaces 102 and 103 may be standalone interfaces separate from any computing device, or may be integrated into computing devices 100 and 101 or connected to an internal interface connector of computing devices 100 and 101. For example, in embodiments where computing devices 100 and 101 are personal computers, network interfaces 102 and 103 may be integrated into a motherboard of the personal computer or connected to a bus of the computer, for example as a PCI, PC card, or other bus-interface-compatible Network Interface Card.

The network further comprises cables 106 and 107 connected to network connections 108 and 109, respectively, which are connected by cables 110 and 111 respectively to a patch panel 112. The cables 110 and 111 are connected through patch panel 112 to hub device 114. Hub device 114 may be, for example, a hub, a switch or a router compatible with the other network elements. In an embodiment, hub device 114 also includes a TDR circuit 115 that is connected by a connecting circuit 116 to at least one of the plurality of connections provided by hub device 114. In an embodiment, connecting circuit 116 is a multiplexing circuit that selectively connects TDR circuit 115 to any of the connections provided by hub device 114, enabling hub device 114 to selectively conduct TDR tests of each connected line. For purposes of terminology, hub device 114 may be considered a special-purpose network interface device.

Cables 106 and 107 may be any connecting devices compatible with the other network elements. In an embodiment, network connections 108 and 109 are jacks that facilitate easy connection of network interfaces 101 and 102 via connecting cables 106 and 107 to the network.

In an exemplary Ethernet-based embodiment of the invention, the cabling used may be CAT5 or higher cable, network connections 108 and 109 may be RJ-45 jacks, and cables 106 and 107 are CAT5 or higher patch cables with RJ-45 connectors. Further, in such embodiments, network interfaces 102 and 103 may be Ethernet transceivers and hub device 114 may be an Ethernet hub, switch or router.

In other embodiments of the invention, networking standards other than Ethernet and physical connection standards other than CAT5 may be used, and in these embodiments, network interfaces 102 and 103, hub device 114, and the various cabling and connectors shown will be designed according to the selected standard, rather than being Ethernet-compatible components. For example, coaxial or fiber optic cabling may be used if desired.

While the exemplary network in FIG. 1 is shown as a fully wired network for simplicity, various connections within the network may be wireless if desired. Also, the network may use a mixture of available wiring, signals, physical level and protocol communications standards, rather than being entirely an Ethernet network or entirely another type of network. The concepts of the present invention may be applied to a variety of networking situations and the form of the network is not essential to the invention.

TDR circuits 104 and 105 are preferably integrated into network interfaces 102 and 103, although in an embodiment these circuits may be provided as standalone devices, that may be associated with network interfaces 102 and 103 if desired. TDR circuit 115 is preferably integrated into hub device 114, although in an embodiment TDR circuit 115 may be provided as a standalone device.

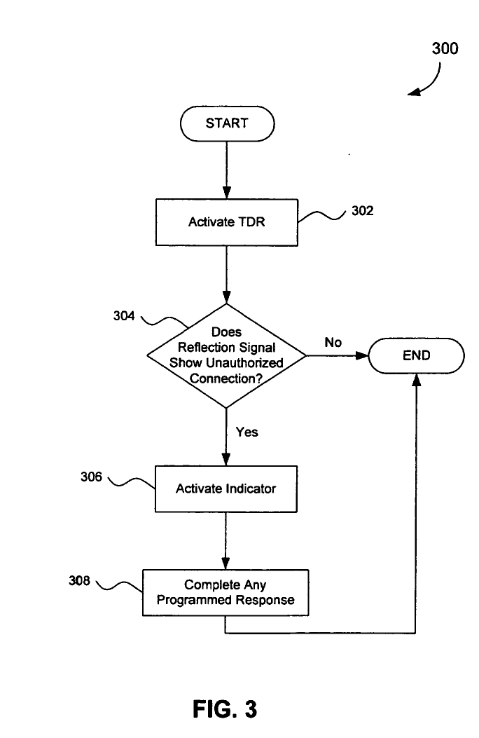

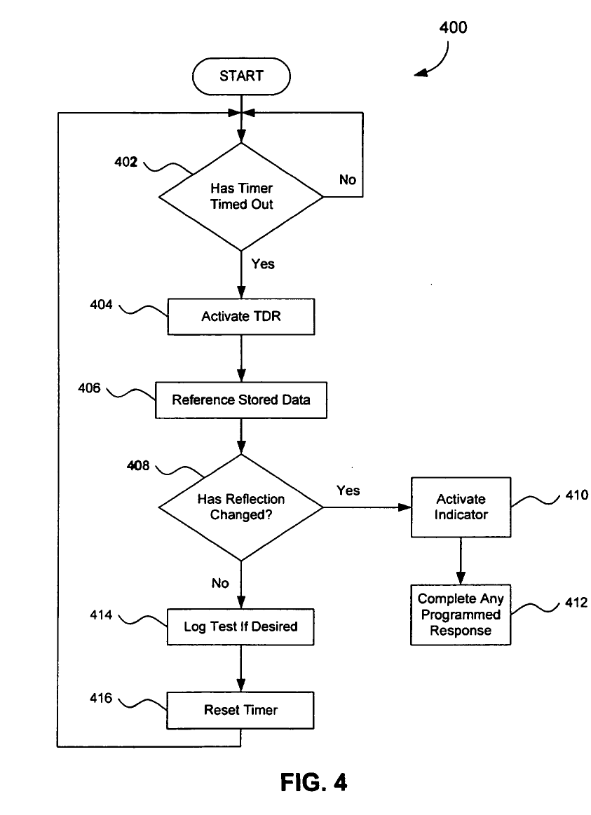

If desired, TDR circuits 104, 105 and 115 may be programmed and designed to perform line testing functions during installation of the network. In addition to any desired setup functions, the TDR circuits are provided with associated software or firmware programs that implement one or more of the process features described herein, and illustrated in FIGS. 3 and 4. The software and/or firmware programs that implement the features disclosed herein may be stored in network interfaces 102 and 103, in hub device 114, in computing devices 100 and 101, or elsewhere in the network. These software and/or firmware programs may be activated manually by a user or automatically, as desired. Automatic operation may be accomplished under remote control from another device in the network, or through a software and/or firmware program that periodically activates the TDR circuits to perform a TDR test. Periodic activation may occur in response to a timer with a predetermined time-out period, in response to a random or variable testing time period determined by the program, or through any other desired timing function.

In the network shown in FIG. 1, assuming that there are no defects in the wiring, activation of TDR circuits 104, 105 and 115 will generate an indication that the network connections appear good and that no unauthorized connections have been detected.

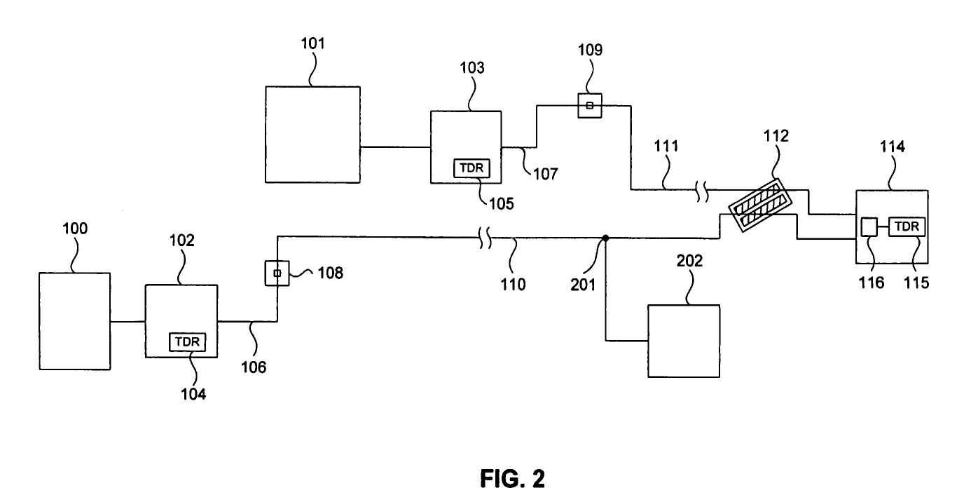

FIG. 2 illustrates the network of FIG. 1 with the addition of a further connection to the network, or “tap” 201. Tap 201 connects a device 202 to the network. Device 202 is shown as a generalized, exemplary device and may have been introduced for any purpose, whether legitimate or illegitimate. For example, device 202 may be an unauthorized device designed to intercept network communications for purposes of identity theft, industrial espionage, or other illicit activity. Device 202 may also be an otherwise authorized device that has been installed by a user in a manner that did not have prior approval and knowledge of the network administrator.

In the network of FIG. 2, when TDR circuit 105 is activated, it will generate an indication that the network connections appear good and that no unauthorized connections have been detected. In contrast, when TDR circuit 104 (or TDR circuit 115 when connected to line 110) is activated, it will detect an anomalous reflection generated by tap 201 and/or device 202 connected to tap 201. In an embodiment, this reflection may be identified as anomalous based on analysis of its signature. In another embodiment, this reflection may be identified as anomalous based on a difference between a baseline reflection signature and a new, different signature detected after installation of the tap. In a further embodiment a possible tap identification may be based on a combination of the foregoing methodologies.

FIG. 3 is a flow chart showing an embodiment of a method 300 of TDR testing in networks to determine unexpected connections and/or taps in the network. This method can be applied using a TDR connected at any desired location in the network. For example, TDRs 104, 105 and/or 115 as shown in FIGS. 1 and 2 could be used in this method.

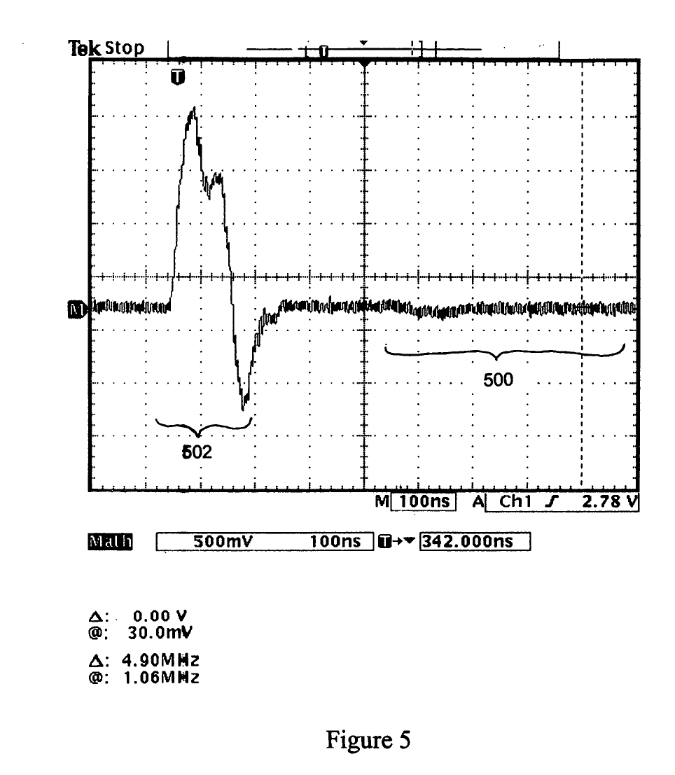

In step 302, the TDR circuit is activated. The TDR circuit transmits a defined waveform into one or more conductors of the cable. In step 304, the TDR circuit detects a reflected signal resulting from the transmission. The system then analyzes the reflected signal to determine whether it shows an unexpected connection. This determination may be made in the TDR circuit, in a processor associated with a network interface device or hub device, as appropriate, or in a processor associated with a connected computing device. The determination may also be made on the basis of waveform signature analysis, as will be explained in more detail with reference to FIGS. 5-8, or may be made on the basis of comparison with stored signature information representing a “normal” state of the network line to determine whether there have been any changes.

If no unexpected connection is detected, the process ends. The process may be repeated periodically as desired. Periodic testing may be performed either automatically or manually as desired. If an unexpected connection is detected, an indicator is activated in step 306. The indicator may be any desired method of providing an indication that an unexpected tap or connection has been detected. For example, a visual and/or audible signal may be generated. As a further example, a message may be displayed for a user, or for a network administrator at an administration station, or a paging signal may be generated. The desired indicators may be selectively generated at a specific station connected to the network, at all stations, or at one or more stations whose communications may be compromised by a possible tap. Test results may be logged at any desired location as part of this process.

Next, in step 308, the method may optionally perform a programmed response to the detection of an unexpected connection. A programmed response may be any desired operation to be performed in response to the detection. Programmed responses may include, for example, further communications or indications of status, or further testing (either TDR or otherwise) by the device that detected the line anomaly, or by one or more other devices connected to the same line (e.g. the hub device may be informed of the anomaly and may conduct a confirming TDR test from the other end). Programmed responses may also include actions to be performed by a person in response to the indication of an unexpected connection. Programmed responses may also include security measures intended to minimize access of an unauthorized device to the network and/or data transmitted via the network. As one example, upon detection of an anomaly, the software or firmware may instruct devices connected to the affected line to cease communications over that line and/or disable any connections on that line to other parts of the network, to prevent an unauthorized connected device from further breaching network security.

FIG. 4 shows another exemplary embodiment of a process for TDR testing to determine when connections and/or taps may have been added to the network. Process 400 shown in FIG. 4 includes an optional timer for automatically activating a test on a periodic basis. If desired, the period between tests may be predetermined as part of the device and software/firmware design. For example, tests may be run continuously, or frequently, such as every few seconds, or less frequently such as once an hour or once a day. Any desired time between tests from zero to infinity may be established if desired. In an embodiment, a system administrator or engineer may set the period between tests to be any desired period based on factors relating to the specific network to be protected.

In step 402, the system determines whether a predetermined time has elapsed since a previous line test. If not, the process continues to loop through step 402. When a predetermined time has elapsed since a previous line test, such that it is time for another test, control passes to step 404.

In step 404 a TDR circuit is activated. The TDR circuit transmits a defined waveform into one or more conductors of the cable. In an embodiment, the TDR circuit sequentially tests each conductor of the cable in pairs. For example, a typical CAT5 cable has four pairs of conductors to be tested. Of course, the conductors may be tested in any desired manner. In some circumstances, it may be sufficient to test a subset of the conductors or it may be desirable to test them individually or in groupings other than color matched pairs. All of the possible sequences and patterns of testing conductors are contemplated by the present invention.

In the embodiment shown in FIG. 4, in step 406, stored data indicative of an expected reflection signature is referenced. This stored data may be stored in an active memory or on a device that is part of the network equipment, part of a computing device, or otherwise associated with the network. In an embodiment, the stored data is generated at a time when the network is believed to be secure from taps, such as during initial installation and testing of the network. The stored data is preferably sufficient to support a comparison between a TDR reflection result and the stored data to determine whether there have been any substantial changes to the reflection result that would indicate a change in condition of the cables, connections, or network topology. Except in cases where a step must inherently be performed after another step, the sequence of steps in this process is not critical. For example, stored data may be accessed in step 406 either before, during, or after the activation of the TDR in step 404. Further, the stored data may be accessed from a nonvolatile storage device every time a TDR test is conducted, or may be brought into memory once and then referenced from active memory as needed when TDR tests occur. Thus, the data for comparison may be stored in any location within the scope of the invention.

In step 408, the reflected signal resulting from the transmission is analyzed to determine whether it shows an unexpected connection. In embodiments where data has been stored indicating a “normal” state of the network line, the detected reflection may be compared with the stored data to determine whether there have been any changes. If desired, the determination of whether there is an unexpected connection may also be made wholly or partially on the basis of waveform signature analysis, as will be explained in more detail with reference to FIGS. 5-8.

If no unexpected connection is detected, control passes to step 414, where the test results may optionally be logged. Then, in step 416, the timer for periodic automatic testing is reset in preparation for the next test cycle. Control then returns to block 402 and the system waits for the timer to indicate that another test should begin.

If an anomaly suggesting an unexpected connection is detected in step 408, an indicator is activated in step 410. The indicator may be any desired method of providing an indication that an unexpected tap or connection has been detected. For example, a visual and/or audible signal may be generated. As a further example, a message may be displayed for a user, or for a network administrator at an administration station, or a paging signal may be generated. The desired indicators may be selectively generated at a specific station connected to the network, at all stations, or at one or more stations whose communications may be compromised by a possible tap. Test results may also be logged at any desired location as part of this process.

Next, in step 412, the method may optionally perform a programmed response to the detection of an unexpected connection. A programmed response may be any desired operation to be performed in response to the detection. Programmed responses may include, for example, further communications or indications of status, or further testing (either TDR or otherwise) by the device that detected the line anomaly, or by one or more other devices connected to the same line. For example, if the anomaly was detected by a network interface device serving a computing device, the hub device to which the network interface device is connected may be informed of the anomaly and may conduct a confirming TDR test from the other end. Programmed responses may also include an action to be taken by a person in response to the indication that an unexpected connection has been detected.

Programmed responses in step 412 may also include security measures intended to minimize access of an unauthorized device to the network and/or data transmitted via the network. As one example, upon detection of an anomaly, the software or firmware may instruct devices connected to the affected line to cease communications over that line and/or disable any connections on that line to other parts of the network, to prevent an unauthorized connected device from further breaching network security.

It will be understood that the methods described with reference to FIGS. 3 and 4 are exemplary, and that the invention is not limited to these specific methods. The steps of these methods can be performed in any desired order that produces a practical result. Further, the features of the different methods disclosed can be selectively implemented and combined in any desired manner. In particular, features shown in either FIG. 3 or FIG. 4 may be omitted and features shown in one embodiment may be added to the other embodiment, as desired. The methods described herein are intended to provide examples of concepts associated with the invention, rather than being limiting.

FIGS. 5 through 8 show exemplary TDR waveforms that can be expected under various cable conditions. These exemplary waveforms can be used as a basis for signature analysis of the reflected waveforms as described herein. Of course, those skilled in the art will appreciate that some variation in waveforms can be expected depending on the installation and its characteristics. A range of waveform signatures for each condition can be obtained with reasonable experimentation, and used as a basis for analysis.

FIG. 5 is a graphical representation of a typical reflection signal 500 received after transmission of a TDR pulse 502 into a cable with a proper 100 Ohm termination. Signal 500 shows virtually no reflection from the cable.

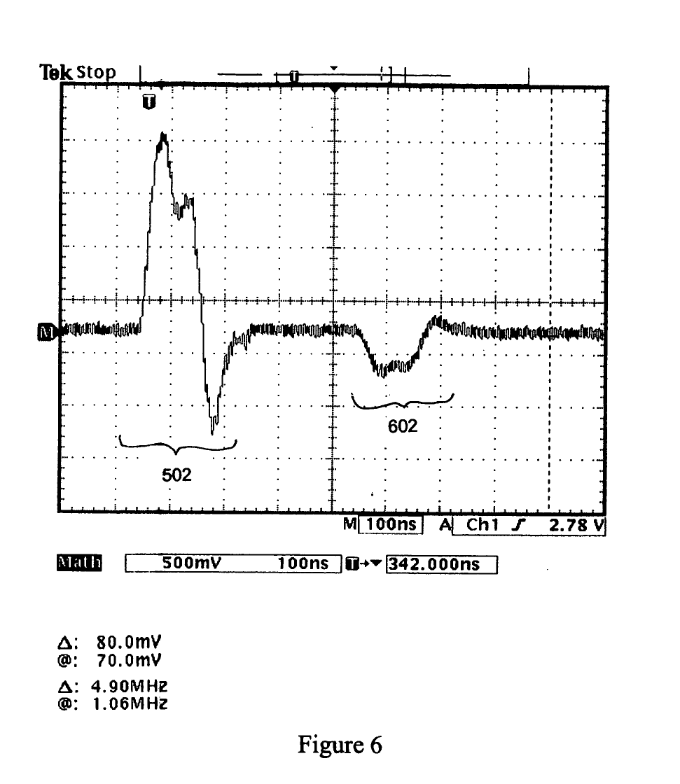

FIG. 6 is a graphical representation of a typical reflection of a TDR pulse in the presence of a tapped connection, as might be seen in the system of FIG. 2. The TDR test pulse 502 is reflected by the tap as pulse or waveform 602. The timing of the appearance of reflection waveform 602 will vary depending on the location of the tap relative to the TDR signal injection and measurement point. In this example, the tap is located approximately 40 meters from the testing point. The distance of the tap from the testing point results in an approximately 400 ns delay between TDR pulse 502 and reflection waveform 602. Reflection waveform 602 is inverted with respect to TDR pulse 502, and in this example has approximately e,fra 1/3 of the amplitude of TDR pulse 502. Thus, the tap in this case can be characterized by its reflection of an inverted waveform 602 having a greatly reduced amplitude in relation to TDR pulse 502.

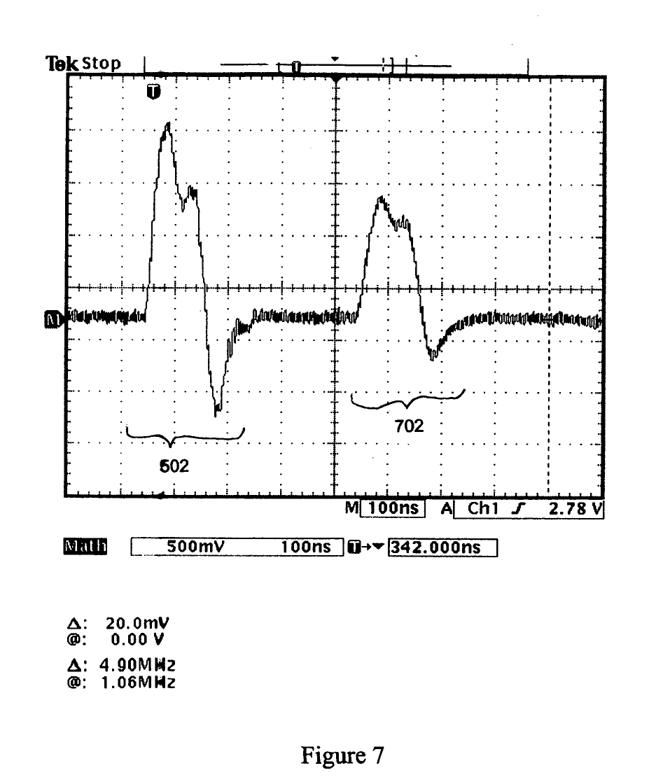

FIG. 7 is a graphical representation of a typical reflection of a TDR pulse 502 where an open cable condition exists. This results in waveform 702, for the case of an open cable condition approximately 40 meters from the test point. Waveform 702 is delayed approximately 400 ns from TDR pulse 502, which has the same polarity and a slightly reduced amplitude.

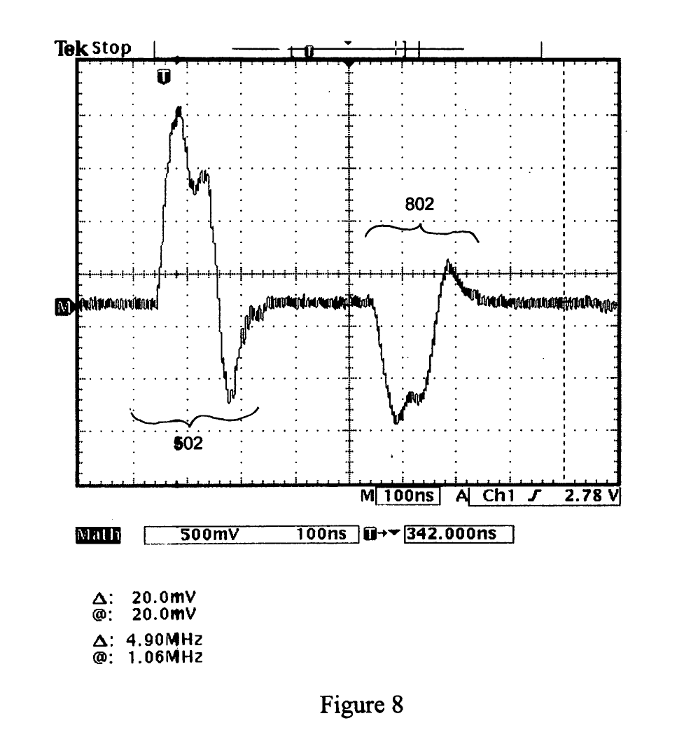

FIG. 8 is a graphical representation of a typical reflection of a TDR pulse 502 where there is a short circuit approximately 40 meters into the cable. The short circuit results in a reflection waveform 802, which in this case is generally an inversion of waveform 702 shown in FIG. 7.

The transmission of a TDR pulse over the link (as described, for example, in step 302 in FIG. 3 and/or step 404 in FIG. 4) may be accomplished using varied methods. In an embodiment, the transmission mechanism may be varied depending on the type of link. As an example, the pulse may be transmitted by first breaking link, or dropping the connection with the link partner. There is a 1.5 second quiet time (as specified in the IEEE 802.3 standard) after link drops in an Ethernet link, and the TDR pulse may optionally be transmitted and evaluated during this quiet time. It should be noted that dropping the link in this manner is a somewhat intrusive action, and briefly interrupts data communication.

In another exemplary embodiment, one or more standard network protocol pulses may be employed as TDR pulses instead of stopping the data link and providing specialized TDR pulses to detect unexpected connections. As an example, in an embodiment a system using a 10 Mbit/s Ethernet transmission standard is provided with constant TDR monitoring without interfering with the data link. Currently, there are three link speeds, 10 Base-T (10 Mbit/s), 100 Base-T (100 Mbit/s) and 1000 Base-T (1 Gbit/s). FIG. 5, in particular, illustrates the use of a 10 Base-T link pulse as the TDR pulse. The link pulse is transmitted between traffic (or packets), or during an idle period. The spacing between each link pulse is about 16 ms which is enough time for detection of a reflection resulting from an unexpected connection such as a wiretap.

In higher-speed connections such as 100 Base-T and 1000 Base-T, idle and traffic transmissions appear similar. Activating TDR in these connections requires breaking the link, reconnecting with 10 Base-T and waiting for a link pulse to be transmitted and then measuring a reflection as in FIG.6. It is not possible for any network in real world to have 100% utilization such that there is no link pulse. Typical network's maximum utilization is below 80% and therefore the periodic presence of a link pulse is virtually guaranteed.

In some embodiments of the invention, one or more general-purpose computer systems and/or one or more special-purpose computer systems may be connected to one or more network interface devices operating in the manner disclosed herein.

The following description of a general-purpose computer system is provided for completeness as an example of one of many different types of computing systems that can be used in conjunction with network transceiver hardware and operating methods disclosed herein. The present invention can be implemented in hardware or as a combination of software and hardware. Consequently, the invention may be implemented in the environment of a computer system or other processing system.

An exemplary computer system 900 is shown in FIG. 9. The computer system 900 includes one or more processors, such as processor 904. Processor 904 can be a special purpose or a general purpose digital signal processor. Processor 904 is connected to a communication infrastructure 906 (for example, a bus or network). Various software implementations are described in terms of this exemplary computer system. After reading this description, it will become apparent to a person skilled in the relevant art how to implement the invention using other computer systems and/or computer architectures.

Computer system 900 also includes a main memory 905, preferably random access memory (RAM), and may also include a secondary memory 910. The secondary memory 910 may include, for example, a hard disk drive 912, and/or a RAID array 916, and/or a removable storage drive 914, representing a floppy disk drive, a magnetic tape drive, an optical disk drive, etc. The removable storage drive 914 reads from and/or writes to a removable storage unit 918. Removable storage unit 918 may be implemented as a floppy disk, magnetic tape, optical disk, USB flash memory, or any other removable storage device. As will be appreciated, the removable storage unit 918 includes a computer usable storage medium having stored therein computer software and/or data.

In alternative implementations, secondary memory 910 may include other similar means for allowing computer programs or other instructions to be loaded into computer system 900. Such means may include, for example, a removable storage unit 922 and an interface 920. Examples of such means may include a program cartridge and cartridge interface (such as that found in video game devices), a removable memory chip (such as an EPROM, or PROM) and associated socket, and other removable storage units 922 and interfaces 920 which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a PCMCIA slot and card, etc. Software and data transferred via communications interface 924 are in the form of signals 928 which may be electronic, electromagnetic, optical or other signals capable of being received by communications interface 924. These signals 928 are provided to communications interface 924 via a communications path 926. Communications path 926 carries signals 928 and may be implemented using wire or cable, fiber optics, a phone line, a cellular phone link, an RF link, a satellite link, and/or other communications channels.

The terms “computer program medium” and “computer usable medium” are used herein to generally refer to media such as removable storage drive 914, a hard disk installed in hard disk drive 912, and signals 928. These computer program products are a means for providing software to computer system 900.

Computer programs (also called computer control logic) are stored in main memory 908 and/or secondary memory 910. Computer programs may also be received via communications interface 924. Such computer programs, when executed, enable the computer system 900 to implement the present invention as discussed herein. In particular, the computer programs, when executed, enable the processor 904 to implement the processes of the present invention, either alone or in conjunction with a network transceiver. Where the invention is implemented using software, the software may be stored in a computer program product and loaded into computer system 900 using raid array 916, removable storage drive 914, hard drive 912 or communications interface 924.

In another embodiment, features of the invention are implemented primarily in hardware using, for example, hardware components such as Application Specific Integrated Circuits (ASICs) and gate arrays. Implementation of a hardware state machine so as to perform the functions described herein will also be apparent to persons skilled in the relevant art(s).

The present invention has been described above with the aid of functional building blocks and method steps illustrating the performance of specified functions and relationships thereof. The boundaries of these functional building blocks and method steps have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof. Thus, the breadth and scope of the present invention should not be limited by any of the above-described exemplary embodiments, but should be defined only in accordance with the following claims and their equivalents.

Selected embodiments of the disclosed system and method provide several useful advantages. Typically, it has not been practical to ensure that network cabling is secure, since such cabling typically runs through walls and above ceiling tiles where it can be physically accessed. The present invention uses existing TDR capabilities, provided in network interface devices for other purposes, to monitor network security. In this manner, the systems and methods disclosed herein provide an inexpensive yet effective method of monitoring network cable integrity and providing an appropriate response in case of an attempted intrusion.

While various embodiments of the present invention have been described above, it should be understood that they have been presented by way of example, and not limitation. It will be apparent to persons skilled in the relevant art that various changes in form and detail can be made therein without departing from the spirit and scope of the invention.

What is claimed is:

1. A monitoring method, comprising the steps of:
providing a network interface device with an integral time domain reflectometry circuit and connecting said network interface device to a network cable;
transmitting a signal into said network cable;
detecting a reflection of said signal using said time domain reflectometry circuit; and
activating an indication if said reflection indicates that said network cable has been tapped.

2. The method of claim 1, wherein said network interface device is one of a hub, a router, a switch, and a transceiver.

3. The method of claim 1, wherein said network interface device is an Ethernet interface device.

4. The method of claim 1, comprising the further steps of:
storing reflection signature data defining a first TDR state of the network cable; and
determining whether said network cable has been tapped based on a comparison of said reflection signature data and said reflection of said signal.

5. The method of claim 1, comprising the further step of periodically repeating said transmitting, detecting, and activating steps.

6. The method of claim 5, comprising the further step of providing an automated timer to control said repeating of said transmitting, detecting, and activating steps.

7. The method of claim 5, wherein said signal periodically transmitted into said network cable is a network link pulse.

8. The method of claim 1, comprising the further step of applying security measures to a portion of the network where a possible tap has been detected.

9. The method of claim 8, wherein said security measures comprise at least partially blocking communications between the network and a tapping device.

10. A network monitoring apparatus, comprising:
a network interface device with an integral time domain reflectometry circuit;
transmitting means for transmitting a signal into a network cable;
processing means for detecting a reflection of said signal and determining whether said network cable has been tapped; and
indicating means for providing an indication when said processing means determines that said network cable has been tapped.

11. The apparatus of claim 10, wherein said network interface device is one of a hub, a router, a switch, and a transceiver.

12. The apparatus of claim 10, wherein said network interface device is an Ethernet interface device.

13. The apparatus of claim 10, further comprising:
storage means for storing reflection signature data defining a first TDR state of the network cable; and
comparison means associated with said processing means for determining whether said network cable has been tapped based on a comparison of said reflection signature data and said reflection of said signal.

14. The apparatus of claim 10, further comprising timing means for periodically actuating said transmitting means and processing means to conduct a TDR test.

15. The apparatus of claim 14, wherein said transmitting means periodically transmits a link pulse signal into the network cable.

16. The apparatus of claim 10, further comprising security means for applying security measures to a portion of the network where a possible tap has been detected.

17. The apparatus of claim 16, wherein said security measures comprise at least partially blocking communications between the network and a tapping device.

18. A monitoring method, comprising the steps of:
connecting a time domain reflectometry circuit to a network cable during data transmission operations;
repeatedly transmitting a signal into said network cable, and
automatically controlling operation of said time domain reflectometry circuit to detect a reflection of said signal using said time domain reflectometry circuit, and activate an indication if said reflection indicates that said network cable has been tapped.

19. The method of claim 18, wherein said time domain reflectometry circuit is integrated with one of a hub, a router, a switch, and a transceiver.

20. The method of claim 19, wherein said time domain reflectometry circuit is integrated with an Ethernet device.

21. The method of claim 19, comprising the further steps of:
storing reflection signature data defining a first TDR state of the network cable; and
determining whether said network cable has been tapped based on a comparison of said reflection signature data and said reflection of said signal.

22. The method of claim 18, comprising the further step of at least partially blocking further communications between the network and a tapping device in a portion of the network where a possible tap has been detected.
